(19) United States
(12) Patent Application Publication
(10) Pub. No.: US 2010/0129579 A1
(43) Pub. Date: May 27, 2010

(54) Rapid Crack Properties in High Performance Pipe

(75) Inventors: John Ashbaugh, Houston, TX (US); Brian Cole, Kingwood, TX (US); Gerhard Guenther, Kemah, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/619,944

(22) Filed: Nov. 17, 2009

Related U.S. Application Data
(60) Provisional application No. 61/117,491, filed on Nov. 24, 2008.

(51) Int. Cl. B32B 1/08; C08F 110/02; C08F 4/52

(52) U.S. Cl. 428/36.9; 526/352; 526/185

(57) ABSTRACT

Pipe articles and methods of forming the same are described herein. The pipe articles generally include a bimodal polyethylene including a greater amount of high molecular weight fraction than low molecular weight fraction and wherein the pipe article exhibits a critical temperature of less than about 0° C. at 5 bar.

### CROSS-REFERENCE TO RELATED APPLICATIONS

This application claims the benefit of U.S. Provisional Patent Application Ser. No. 61/117,491, filed Nov. 24, 2008.

### FIELD

Embodiments of the present invention generally relate to pipes formed of ethylene based polymers.

### BACKGROUND

As reflected in the patent literature, multi-modal polyolefins have been used in the production of various products, e.g., film, sheet, and pipe. While the products formed from these multi-modal polyolefins may exhibit strength and other performance properties, multi-modal polyolefins are often limited in their ability to avoid cracks and brittleness at sub-zero temperatures. Therefore, a need exists to develop pipes formed from multi-modal polyolefins having improved resistance to cracking.

### SUMMARY

Embodiments of the present invention include pipe articles. The pipe articles generally include a bimodal polyethylene including a greater amount of high molecular weight traction than low molecular weight fraction and wherein the pipe article exhibits a critical temperature of less than about 0° C. at 5 bar.

Embodiments further include methods of forming a pipe articles. The methods generally include providing a bimodal polyethylene including from about 52 wt. % to about 54 wt. % high molecular weight fraction and from about 48 wt. % to about 46 wt. % low molecular weight fraction and forming a pipe from the bimodal polyethylene, wherein the pipe wherein the pipe article exhibits a critical temperature of less than about −5° C. at 5 bar.

### DETAILED DESCRIPTION

Introduction and Definitions

A detailed description will now be provided. Each of the appended claims defines separate invention, which for infringement purposes is recognized as including equivalents to the various elements or limitations specified in the claims. Depending, on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Unless Otherwise designated herein, all testing methods are the current methods at the time of filing.

As used herein, “room temperature” means that a temperature difference of a few degrees does not matter to the phenomenon under investigation, such as a preparation method. In some environments, room temperature may include a temperature of from about 20° C. to about 28° C. (68° F. to 82° F.), while in other environments, room temperature may include a temperature of from about 50° F. to about 90° F., for example. However, room temperature measurements generally do not include close monitoring of the temperature of the process and therefore such a recitation does not intend to bind the embodiments described herein to any predetermined temperature range.

Various ranges are further recited below. It should be recognized that unless stated otherwise, it is intended that the endpoints are to be interchangeable. Further, any point within that range is contemplated as being disclosed herein.

Embodiments of the invention generally include pipes formed from a bimodal polyethylene.

### Catalyst Systems

Catalyst systems useful for polymerizing olefin monomers include any catalyst system known to one skilled in the art. For example, the catalyst system may include metallocene catalyst systems, single site catalyst systems, Ziegler-Natta catalyst systems or combinations thereof, for example. As is known in the art, the catalysts may be activated for subsequent polymerization and may or may not be associated with a support material. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components. such as a catalyst support, a cocatalyst and/or one or more electron donors, for example.

A specific example of a Ziegler-Natta catalyst includes a metal component generally represented by the formula:

MR^{A}ₓ

wherein M is a transition metal. R^{A} is a halogen, an alkoxy or a hydrocarboxyl group and x is the valence of the transition metal. For example, x may be from 1 to 4.

The transition metal may be selected from Groups IV through VIB (e.g., titanium, vanadium or chromium), for example. R^{A} may be selected from chlorine, bromine, carbonates, esters, or alkoxy groups in one embodiment. Examples of catalyst components include TiCl₄, TiBr₄₁, Ti(OC₂H₅)₃Cl, Ti(OC₃H₇)₂Cl₂, Ti(OC₆H₁₃)₂Cl₂, TiOC₃H₅)₂Br₂ and Ti(OC₁₂H₂₅)Cl₃, for example.

Those skilled in the art will recognize that a catalyst may be “activated” in sonic way before it is useful for promoting polymerization. As discussed further below, activation may be accomplished by contacting the catalyst with a Ziegler-Natta activator (Z-N activator), which is also referred to in some instances as a “cocatalyst.” Embodiments of such Z-N activators include organoaluminum compounds, such as trimethyl aluminum (TMA), triethyl aluminum (TEAl) and triisobutyl aluminum (TIBAl), for example.

The Ziegler-Natta catalyst system may further include one or more electron donors, such as internal electron donors and/or external electron donors. Internal electron donors may be used to reduce the atactic form of the resulting polymer, thus decreasing the amount of xylene solubles in the polymer. The internal electron donors may include amines, amides, esters, ketones, nitriles, ethers, phosphines, diethers, succinates. phthalates, or dialkoxybenzenes, for example. (See. U.S. Pat. No. 5,945,366 and U.S. Pat. No. 6,399,837, which are incorporated by reference herein).

External electron donors may be'used to further control the amount of atactic polymer produced. The external electron donors may include monofunctional or polyfunctional carboxylic acids, carboxylic anhydrides, carboxylic esters, ketones, ethers, alcohols, lactones. organophosphorus compounds and/or organosilicon compounds. In one embodiment, the external donor may include diphenyldimethoxysilane (DPMS), cyclohexymethyldimethoxysilane (CDMS), diisopropyldimethoxysilane and/or dicyclopentyldimethoxysilane (CPDS), example. The external donor may be the same or different from the internal electron donor used.

The components of the Ziegler-Natta catalyst system (e.g., catalyst, activator and/or electron donors) may or may not be associated with a support, either in combination with each other or separate from one another. The Z-N support materials may include a magnesium dihalide, such as magnesium dichloride or magnesium dibromide, or silica, for example.

In one specific embodiment, the Ziegler-Natta catalyst is formed by contacting a magnesium dialkoxide compound with sequentially stronger chlorinating and/or titanating, agents. For example, the Ziegler-Natta catalyst may include those described in U.S. Pat. No. 6,734,134 and U.S. Pat No. 6,174,971, which are incorporated by reference herein.

The Ziegler-Natta catalysts may be formed by methods generally including contacting an alkyl magnesium compound with an alcohol to form a magnesium dialkoxide compound. Such reaction may occur at a reaction temperature ranging from room temperature to about 90° C. for a time of up to about 10 hours, for example. The alcohol may be added to the alkyl magnesium compound in an equivalent of from about 0.5 to about 6 or from about 1 to about 3, for example.

The alkyl magnesium compound may be represented by the following formula:

MgR R²R²

wherein R¹ and R² are independently selected from C₁ to C₁₀ alkyl groups. Non-limiting illustrations of alkyl magnesium compounds include butyl ethyl magnesium (BEM), diethyl magnesium, dipropyl magnesium and dibutyl magnesium, for example.

The alcohol may be represented by the formula:

R³OH

wherein R³ is selected from C₂ to C₂₀ alkyl groups. Non-limiting illustrations of alcohols generally include butanol, isobutanol and 2-ethylhexanol, for example.

The methods may then include contacting the magnesium dialkoxide compound with a first agent to form reaction product “A”. Such reaction may occur in the presence of an inert solvent. A variety of hydrocarbons can be used as the inert solvent, but any hydrocarbon selected should remain in liquid form at all relevant reaction temperatures and the ingredients used to form the supported catalyst composition should be at least partially soluble in the hydrocarbon. Accordingly, the hydrocarbon is considered to be a solvent herein, even though in certain embodiments the ingredients are only partially soluble in the hydrocarbon.

Suitable hydrocarbon solvents include substituted and unsubstituted aliphatic hydrocarbons and substituted and unsubstituted aromatic hydrocarbons. For example, the inert solvent may include hexane, heptane, octane, decane, toluene, xylene, dichloromethane, chloroform, 1-chlorobutane or combinations thereof, for example.

The reaction may further occur at a temperature of from about 0° C. to about 100° C. or from about 20° C. to about 90° C. for a time of from about 0.2 hours to about 24 hours or from about 1 hour to about 4 hours, for example.

Non-limiting examples of the first agent are generally represented by the following formula:

ClA(OₓR⁴)_{y}

wherein A is selected from titanium, silicon, aluminum, carbon, tin and germanium, R⁴ is selected from C₁ to C₁₀ alkyls, such as methyl, ethyl, propyl and isopropyl, x is 0 or 1 and y is the valence of A minus 1. Non-limiting illustrations of first agents include chlorontanituntriisopropoxide ClTi(O¹Pr)₃ and ClSi(Me)₃, for example.

The methods may then include contacting reaction product “A” with a second agent to form reaction product “B”. Such reaction may occur in the presence of an inert solvent. The inert solvents may include any of those solvents previously discussed herein, for example. The reaction may further occur at a temperature of from about 0° C. to about 100° C. or from about 20° C. to about 90° C. for a time of from about 0.2 hours to about 36 hours or from about 1 hour to about 4 hours, for example.

The second agent may be added to reaction product “A” in an equivalent of from about 0.5 to about 5, or from about 1 to about 4 or from about 1.5 to about 2.5, for example.

The second agent may he represented by the following formula:

TiCl₄/Ti(OR⁵)₄

wherein R⁵ is selected from C₂ to C₂₀ alkyl groups. Non-limiting illustrations of second agents include blends of titanium chloride and titanium alkoxides, such as TiCl₄/Ti(OBu)₄. The blends may have an equivalent of TiCl₄:Ti(OR⁵)₄ of from about 0.5 to about 6 or from about 2 to about 3, for example.

The method may then include contacting reaction product “B” with a third agent to form reaction product “C”. Such reaction may occur in the presence of an inert solvent. The inert solvents may include any of those solvents previously discussed herein, for example. The reaction may further occur at room temperature, for example.

Non-limiting illustrations of third agents include metal halides. The metal halides may include any metal halide known to one skilled in the art, such as titanium tetrachloride (TiCl₄), for example. The third agent may be added in a equivalent of from about 0.1 to about 5. or from about 0.25 to about 4 or from about 0.45 to about 2.5, for example.

The method may further include contacting reaction product “C” with a fourth agent to form reaction'product “D”. Such reaction may occur in the presence of an inert solvent. The inert solvents may include any of those solvents previously discussed herein, for example. The reaction may further occur at room temperature, for example.

The fourth agent may be added to the reaction product “C” in an equivalent of from about 0.1 to about 5, or from about 0.25 to about 4 or from about 0.45 to about 2.0, for example.

Non-limiting illustrations of fourth agents include metal halides. The metal halides may include any metal halide previously described herein.

The method may then include contacting reaction product “D” with a fifth agent to form the catalyst component. The fifth agent may be added to the reaction product “D” in an equivalent of from about 0.1 to about 2 or from 0.5 to about 1.2, for example.

Non-limiting illustrations of fifth agents include organoaluminum compounds. The organoaluminum compounds may include aluminum alkyls having the following formula:

AlR⁶₃

wherein R⁶ is a C₁ to C₁₀ alkyl compound. Non-limiting illustrations of the aluminum alkyl compounds generally include trimethyl aluminum (TMA), triisobutyl aluminum (TIBAl), triethyl aluminum (TEAl), n-octyl aluminum and n-hexyl aluminum, for example.

### Polymerization Processes

As indicated elsewhere herein, catalyst systems are used to form polyolefin compositions. Once the catalyst system is prepared, as described above and/or as known to one skilled in the art, a variety of processes may be carried Out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein).

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containina one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein).

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double-jacketed pipe or heat exchanger, for example.

Alternatively, other types of polymerization processes may be used, such as stirred reactors in series, parallel or combinations thereof for example. Upon removal from the reactor, the polymer may be passed to a polymer recovery system for further processing, such as addition of additives and/or extrusion, for example.

In one or more embodiments, the polymerization process includes the production of multi-modal polyolefins. As used herein, the term “multi-modal” refers to a polyolefin exhibiting at least two distinct molecular weight fractions. For example. the polymers may exhibit bimodal molecular weight distributions (i.e., they are bimodal polymers), such as a high molecular weight fraction and a low molecular weight fraction.

In one or more embodiments, the polymerization process includes the production of bimodal polyolefins. One or more embodiments of the invention may include passing a slurry through at least two reaction zones (e.g., a bimodal process). As used herein, the term “bimodal process” refers to a polymerization process including a plurality of reaction zones (e.g., two reaction zones) that produce a polymer exhibiting a bimodal molecular weight distribution (e.g., a bimodal polymer). For example, a single composition including at least one identifiable high molecular weight fraction and at least one identifiable low molecular weight fraction is considered to be a “bimodal” polyolefin.

The high molecular weight fraction exhibits a molecular weight that is greater than the molecular weight of the low molecular weight fraction. The high molecular weight fraction may have a molecular weight. of from about 50,000 to about 10,000,000, or from about 60,000 to about 5,000,000 or from about 65,000 to about 1,000,000, fir example. In contrast, the low molecular weight fraction may have a molecular weight of from about 500 to about 50,000, or from about 525 to about 40,000 or from about 600 to about 35,000, for example.

The bimodal polymers may have a ratio of high molecular weight fraction to low molecular weight fraction of from about 80:20 to about. 20:80, or from about 70:30 to about 30:70 of from about 60:40 to about 40:60, for example.

The bimodal polyolefins may he formed in a plurality of reactors in series. The reactor can include any reactors or combination of reactors, as described above. In one or more embodiments, the same catalyst is utilized in both reactors. The high molecular weight fraction and the low molecular weight fraction can be prepared in any order in the reactors, e.g., the low molecular weight fraction may be formed in the first reactor and the high molecular weight fraction in the second reactor, or vise versa, for example.

### Polymer Product

The polymers (and blends thereof) formed via the processes described herein may include, but are not limited to, linear low density polyethylene, elastomers, plastomers, high density polyethylenes, low density polyethylenes, medium density polyethylenes, bimodal polyethylene, bimodal polypropylene, polypropylene and polypropylene copolymers, for example.

One or more embodiments include ethylene based polymers. As used herein, the term “ethylene based polymers” refers to polymers including at least about 50 wt. %, or at least about 80 wt. % ethylene. or at least about 85 wt. % ethylene, or at least about 90 wt. % ethylene, or at least about 95 wt. % ethylene or at least about 98 wt. % ethylene, for example.

In one embodiment, ethylene based polymers may have a density of from about 0.86 g/cc to about 0.97 g/cc, or from about 0.90 g/cc to about 0.97 g/cc or from about 0.93 g/cc to about 0.97 g/cc, for example.

Such ethylene based polymers may have a molecular weight distribution of from about 1.5 to about 30 or from about 5 to about 25, for example.

The ethylene polymers may have a melt index (Ml₂) of from about 0.001 dg/min to about 1000 dg/min., or from about 0.01 dg/min. to about 100 dg/min., or from about 0.02 dg/min. to about 50 dg/min. or from about 0.03 dg/min. to about 10 dg/min, for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags. rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

In one or more embodiments, the polymers are utilized to form pipe articles. For example, the pipe articles may include pipe, tubing, molded fittings, pipe coatings and combinations therefore. The pipe articles may be utilized in industrial/chemical processes, mining operations, gas distribution, potable water distribution, gas and oil production, fiber optic conduit, sewer systems and pipe relining. for example.

Rapid crack propagation (RCP) is an important performance characteristic of high performance pipe because the pipe material needs to be able to stop or arrest the growth of an initiated crack. If RCP properties are inadequate, the crack will grow rapidly and may open along a large section of pipe. Pipe materials may become brittle upon exposure to cold temperatures, further exacerbating RCP. Therefore, resistance to RCP can be measured by a pipe material's critical temperature. As used herein, the term “critical temperature” refers to the temperature where the response to an impact changes from ductile (point at which a crack is arrested) to brittle (point at which a crack grows).

Unexpectedly, embodiments of the invention are capable of forming pipe exhibiting improved resistance to rapid crack propagation (RCP). For example, embodiments of the invention are capable of forming pipe exhibiting a critical temperature (as measured by ISO 13477:1997(E)) of less than about 0° C., or less than about −5° C. or less than about −10° C.

In one embodiment, the ethylene based polymers have a PENT (Pennsylvania Notch Tensile Test) of from about 500 hours to about 12,000 hours, or from about 1,500 hours to about 5,000 hours, or from about 3,000 hours to about 5,000 hours or from about 3,000 hours to about 8,000 hours, for example. Unexpectedly, it has been observed that embodiments of the invention are able to produce pipe having the stated critical temperatures without sacrificing PENT performance.

### Examples

The invention having been generally described, the following example is provided merely to illustrate certain embodiments of the invention, and to demonstrate the practice and advantages thereof. It is understood that the examples are given by way of illustration and are not intended to limit the scope of the specification or the claims in any manner.

As used herein, Polymer “A” was a bimodal high density pipe grade commercially available from total Petrochemicals USA Inc., as 3344N.

As used herein, Polymer “B” was a bimodal high density pipe grade produced using the catalyst described via the catalyst preparation process described below and exhibiting a LMW/HMW split of 50.3:49.7.

As used herein, Polymer “C” was a bimodal high density pipe grade produced using the catalyst preparation process described below and exhibiting a LMW/HMW split of 47.2:52.8.

The rapid crack propagation (RCP) resistance of the samples was determined according to a method called the S4 test (Small Scale Steady State), which has been developed at Imperial College, London, and which is described in ISO 13477:1997(E). According to the RCP-S4 test, each pipe tested had an axial length of 860 mm. The outer diameter of each pipe was 110 mm and each pipe's wall thickness was 10 mm. When determining the RCP properties of each pipe in connection with the present invention, the outer diameter and the wall thickness have been selected to be 110 mm and 10 mm, respectively. The exterior of each pipe was at ambient pressure (atmospheric pressure), the pipes were pressurized internally, and the internal pressure of the pipes was kept constant at a pressure of 0.5 MPa positive pressure. Discs were mounted on the shafts inside each pipe to prevent decompression during the tests. A knife projectile was shot, with well-defined forms, towards the pipes in order to start rapidly running axial cracks. The test equipment was adjusted in such a manner that crack initiation took place in the pipe material involved. The axial crack length in the measuring zone was measured for each test and is plotted against the set test temperature. If the crack length exceeded 440 mm, the crack was assessed to have propagated. If the pipe passed the test at a given temperature, the temperature was lowered successively until a temperature was reached, at which the pipe no longer passed the test. The critical temperature (T_{crit}) was recorded. The results of the tests are shown in Table 1.

TABLE 1

| | Polymer A | Polymer B | Polymer C |
|---|---|---|---|
| Mn | 13414 | 13028 | 14079 |
| Mw | 242569 | 258361 | 302170 |
| Mz | 1373384 | 1528890 | 2091419 |
| Density (g/cc) | 0.9480 | 0.9490 | 0.9470 |
| Critical Temperature | 12 | 1 | −12 |
| T_{crit} (° C.) @ 5 bar | | | |
| PENT (hours) | 112 | 1780 | 4020 |

Unexpectedly, the critical temperature was improved significantly when the bimodality of the resin is shifted to a lower split having a higher proportion of high molecular weight polymer.

While the foregoing is directed to embodiments of the present invention, other and further embodiments of the invention may be devised without departing from the basic scope thereof and the scope thereof is determined by the claims that follow.

What is claimed is:

1. A pipe article comprising:
a bimodal polyethylene comprising a greater amount of high molecular weight fraction than low molecular weight fraction and wherein the pipe article exhibits a critical temperature of less than about 0° C. at 5 bar.

2. The pipe article of claim 1, wherein the bimodal polyethylene is formed by a Ziegler-Natta catalyst, wherein the Ziegler-Natta catalyst is formed by:
contacting an alkyl magnesium compound with an alcohol to form a magnesium dialkoxide compound;
contacting the magnesium dialkoxide compound with a plurality of first agents to form reaction product “A”;
contacting reaction product “A” with a second agent to :form reaction product “B”, wherein the second agent comprises a transition metal and a halogen;
contacting reaction product “B” with a third agent to form reaction product “C”, wherein the third agent comprises a first metal halide and wherein the third agent is a stronger halogenating agent than the second agent;
optionally contacting reaction product “C” with a fourth agent to form reaction product “D”, wherein the fourth agent comprises a second metal halide and wherein the fourth agent is a stronger halogenating agent than the third agent; and
contacting reaction product “D” with fifth agent to form a Ziegler-Natta catalyst component, wherein the filth agent comprises an organoaluminum compound

3. The pipe article of claim 1, wherein the pipe article exhibits a critical temperature of less than about −5° C. at 5 bar.

4. The pipe article of claim 1, wherein the bimodal polyethylene comprises a ratio of high molecular weight fraction to low molecular weight fraction of at least about 80:20 to about 50.1:49.9.

5. The pipe article of claim 1, wherein the high molecular weight fraction exhibits a molecular weight (M_{w}) of from about 65,000 to about 1,000,000.

6. The pipe article of claim 1, wherein the low molecular weight fraction exhibits a molecular weight (M_{w}) of from about 600 to about 35,000.

7. The pipe article of claim 1, wherein the bimodal polyethylene comprises at least about 85 wt. % polyethylene.

8. The pipe article of claim 1, wherein the bimodal polyethylene comprises at least about 98 wt. % polyethylene.

9. The pipe article of claim 1, wherein the bimodal polyethylene exhibits a molecular weight distribution of from about 5 to about 25.

10. The pipe article of claim 1, wherein the bimodal polyethylene exhibits a melt index (Ml₂) of from about 0.03 dg/min to about 10 dg/min.

11. The pipe article of claim 1, wherein the pipe article exhibits a Pennsylvania Notch Tensile Test (PENT) of from about 500 to about 10,000.

12. A method of forming a pipe article comprising:
providing a bimodal polyethylene comprising from about 52 wt. % to about 54 wt. % high molecular weight fraction and from about 48 wt. % to about 46 wt. % low molecular weight fraction; and
forming a pipe from the bimodal polyethylene, wherein the pipe wherein the pipe article exhibits a critical temperature of less than about −5° C. at 5 bar.

13. The method of claim 12, wherein. the bimodal polyethylene is formed by a Ziegler-Natta catalyst, wherein the Ziegler-Natta catalyst is formed by:
contacting an alkyl magnesium compound with an alcohol to form a magnesium dialkoxide compound;
contacting the magnesium dialkoxide compound with a plurality of first agents to form reaction product “A”;
contacting reaction product “A” with a second agent to form reaction product “B”, wherein the second agent comprises a transition metal and a halogen;
contacting reaction product “B” with a third agent to form reaction product “C”, wherein the third agent comprises a first metal halide and wherein the third agent is a stronger halogenating agent than the second agent;
optionally contacting reaction product “C” with a fourth agent to form reaction product “D”, wherein the fourth agent comprises a second metal halide and wherein the fourth agent is a stronger halogenating agent than the third agent; and
contacting reaction product “D” with fifth agent to form a Ziegler-Natta catalyst component, wherein the fifth agent comprises an organoaluminum compound

15. The method of claim 12, wherein the high molecular weight fraction exhibits a molecular weight (M_{w}) of from about 65,000 to about 1,000,000.

16. The method of claim 12, wherein the low molecular weight fraction exhibits a molecular weight (M_{w}) of from about 600 to about 35,000.

17. The method of claim 12, wherein the pipe article exhibits a Pennsylvania Notch Tensile Test (PENT) of from about 500 to about 10,000.
